(19) United States
(12) Patent Application Publication
(10) Pub. No.: US 2024/0334268 A1
(43) Pub. Date: Oct. 3, 2024

(54) RACH-LESS HANDOVER FOR MOBILITY IN WIRELESS COMMUNICATION NETWORKS

(71) Applicant: Samsung Electronics Co., Ltd., Suwon-si (KR)

(72) Inventors: Shiyang Leng, Allen, TX (US); Anil Agiwal, Allen, TX (US); Carmela Cozzo, San Diego, CA (US)

(21) Appl. No.: 18/614,593

(22) Filed: Mar. 22, 2024

Related U.S. Application Data
(60) Provisional application No. 63/456,320, filed on Mar. 31, 2023.
(60) Provisional application No. 63/457,635, filed on Apr. 6, 2023.
(60) Provisional application No. 63/598,241, filed on Nov. 13, 2023.

(51) Int. Cl. H04W 36/00; H04B 17/318; H04W 56/00; H04W 72/1268

(52) U.S. Cl. CPC H04W 36/00725; H04B 17/328; H04W 56/0015; H04W 56/0045; H04W 72/1268

(57) ABSTRACT

Methods and apparatuses for a RACH-less handover for a mobility operation in a wireless communication system. A method of a UE comprises: receiving a first message including configuration information for a RACH-less HO; determining whether the configuration information includes the CG configuration or the beam indication; identifying: a CG PUSCH occasion based on a determination that the configuration information includes the CG configuration, or a TCI state ID or a SSB index based on a determination that the configuration information includes the beam indication; and transmitting, to the target cell: an uplink signal including a second message in response to the first message at the identified CG PUSCH occasion when the configuration information includes the CG configuration, or the uplink signal based on an uplink grant received in a PDCCH, the PDCCH being monitored based on the beam indication when the configuration information includes the beam indication.

### CROSS-REFERENCE TO RELATED APPLICATIONS AND CLAIM OF PRIORITY

The present application claims priority to:
U.S. Provisional Patent Application No. 63/456,320, filed on Mar. 31, 2023;
U.S. Provisional Patent Application No. 63/457,635, filed on Apr. 6, 2023; and
U.S. Provisional Patent Application No. 63/598,241, filed on Nov. 13, 2023. The contents of the above-identified patent documents are incorporated herein by reference.

### TECHNICAL FIELD

The present disclosure relates generally to wireless communication systems and, more specifically, the present disclosure relates to a random access channel (RACH)-less handover for a mobility operation in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a RACH-less handover for a mobility operation in a wireless communication system.

In one embodiment, a user equipment (UE) in a wireless communication system is provided. The UE comprises a transceiver configured to receive a first message including configuration information for performing a random access channel-less handover (RACH-less HO) to a target cell, wherein the configuration information includes a configured grant (CG) configuration or a beam indication. The UE further comprises a processor operably coupled with the transceiver, the processor configured to: determine whether the configuration information includes the CG configuration or the beam indication; identify a CG physical uplink shared channel (PUSCH) occasion based on a determination that the configuration information includes the CG configuration, or identify a transmission configuration indication (TCI) state identifier (ID) or a synchronization signal/physical broadcast channel block (SSB) index based on a determination that the configuration information includes the beam indication. The transceiver of the UE is further configured to: transmit, to the target cell, an uplink signal including a second message in response to the first message at the identified CG PUSCH occasion when the configuration information includes the CG configuration, or transmit, to the target cell, the uplink signal based on an uplink grant received in a physical downlink control channel (PDCCH), the PDCCH being monitored based on the beam indication when the configuration information includes the beam indication.

In another embodiment, a method of a UE in a wireless communication system is provided. The method comprises: receiving a first message including configuration information for performing a RACH-less HO to a target cell, wherein the configuration information includes a CG configuration or a beam indication; determining whether the configuration information includes the CG configuration or the beam indication; identifying: (i) a CG PUSCH occasion based on a determination that the configuration information includes the CG configuration or the (ii) a TCI state ID or a SSB index based on a determination that the configuration information includes the beam indication; and transmitting, to the target cell: (i) an uplink signal including a second message in response to the first message at the identified CG PUSCH occasion when the configuration information includes the CG configuration, or (ii) the uplink signal based on an uplink grant received in a PDCCH, wherein the PDCCH is monitored based on the beam indication when the configuration information includes the beam indication.

In yet another embodiment, a BS in a wireless communication system is provided. The BS comprises a processor configured to generate a first message including configuration information for performing a RACH-less HO, wherein whether the configuration information includes the CG configuration or the beam indication is determined, wherein the configuration information includes a CG configuration or a beam indication. The BS further configures a transceiver operably coupled to the processor, the transceiver configured to transmit the first message that is used for performing a RACH-less HO to a target cell, wherein a CG PUSCH occasion is identified based on a determination that the configuration information includes the CG configuration, or a TCI state ID or a SSB is identified based on a determination that the configuration information includes the beam indication, and wherein an uplink signal including a second message in response to the first message at the identified CG PUSCH occasion is received for the target cell when the configuration information includes the CG configuration, or the uplink signal based on an uplink grant received in a PDCCH is received for the target cell, the PDCCH being monitored based on the beam indication when the configuration information includes the beam indication.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIGS. 6A and 6B illustrate flowcharts of UE method for a RACH-less HO according to embodiments of the present disclosure;

FIG. 7 illustrates a flowchart of BS method for a RACH-less HO according to embodiments of the present disclosure; and

FIG. 8 illustrates a flowchart of a UE method for RACH-less handover for a mobility operation in a wireless communication system according to embodiments of the present disclosure.

### DETAILED DESCRIPTION

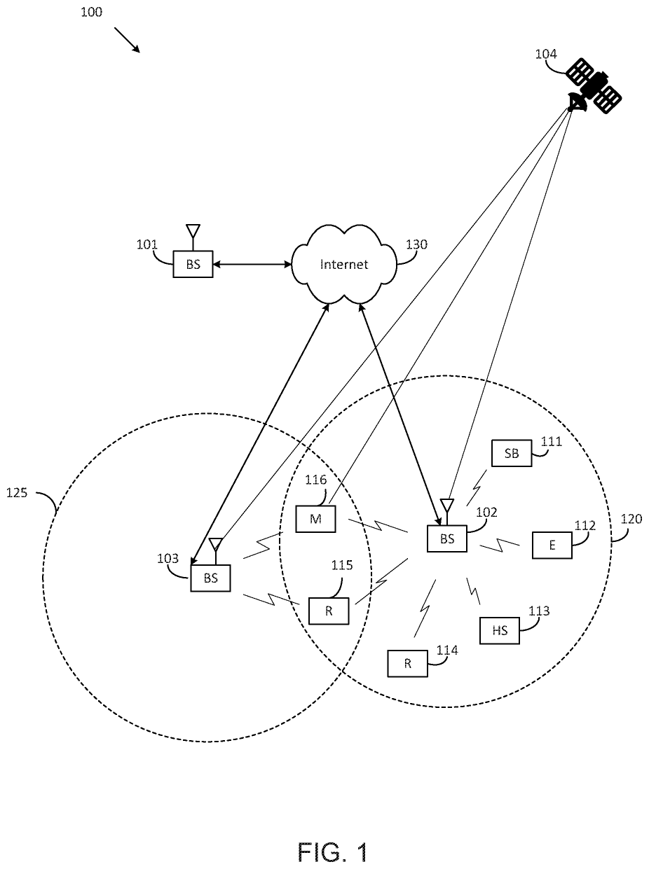

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: “3GPP, TS 38.300 v17.3.0, 5G; NR; NR and NG-RAN Overall Description; Stage 2”; “3GPP, TS 38.331 v17.3.0, 5G; NR; Radio Resource Control (RRC); Protocol specification”; and “3GPP, TS 38.321 v17.3.0, NR; Medium Access Control (MAC) protocol specification”; “3GPP, TS 38.214 v17.3.0, NR; Physical layer procedures for data”; “3GPP, TR 38.811 v15.2.0, Study on NR to support non-terrestrial networks”; and “3GPP, TR 38.821 v16.0.0, Solutions for NR to support non-terrestrial networks (NTN).”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

An NTN refers to a network, or segment of networks using RF resources on board a communication satellite (or unmanned aircraft system platform) (e.g., communication satellite(s) 104). Considering the capabilities of providing wide coverage and reliable service, an NTN is envisioned to ensure service availability and continuity ubiquitously. For instance, an NTN can support communication services in unserved areas that cannot be covered by conventional terrestrial networks, in underserved areas that are experiencing limited communication services, for devices and passengers on board moving platforms, and for future railway/maritime/aeronautical communications, etc.

As described in more detail below, one or more of the UEs 111-116 include circuitry, programing, or a combination thereof, for an NTN neighbor cell measurement operation in a wireless communication system. In certain embodiments, and one or more of the gNBs 101-103 includes circuitry, programing, or a combination thereof, to support an NTN neighbor cell measurement operation in a wireless communication system.

As described in more detail below, one or more of the UEs 111-116 include circuitry, programing, or a combination thereof, for supporting a RACH-less handover for a mobility operation in a wireless communication system. In certain embodiments, and one or more of the gNBs 101-103 includes circuitry, programing, or a combination thereof, for supporting a RACH-less handover for a mobility operation in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

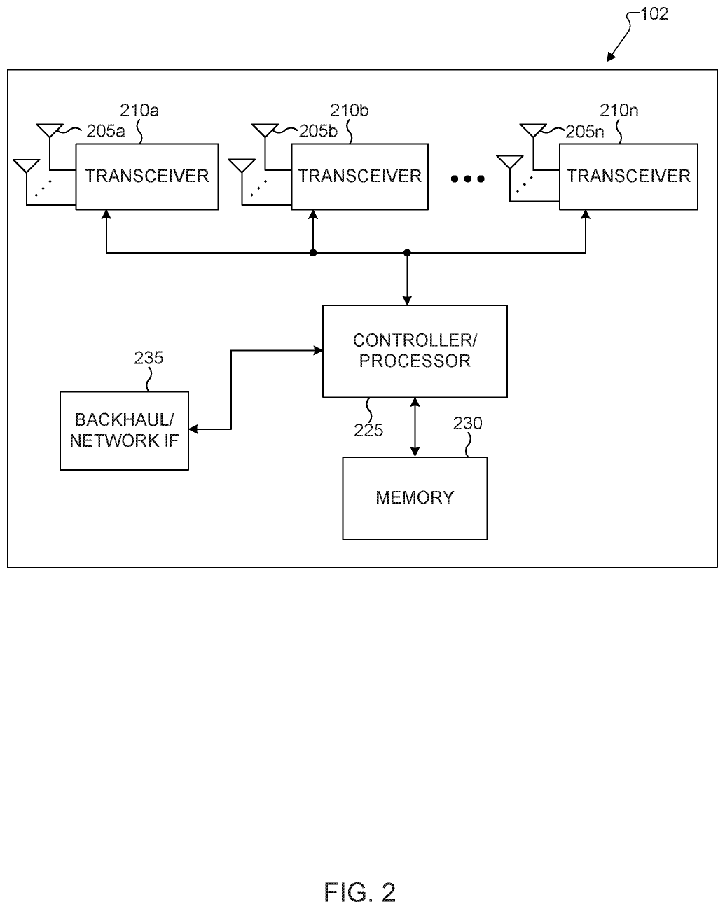

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process. The controller/processor 225 is also capable of executing programs and other processes resident in the memory 230, such as processes for supporting a RACH-less handover for a mobility operation in a wireless communication system.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

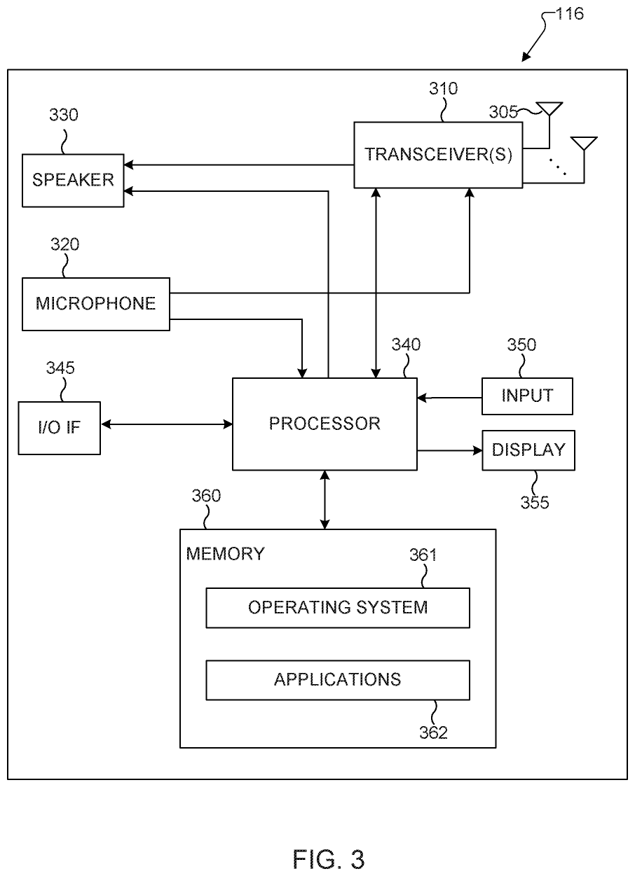

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for a RACH-less handover for a mobility operation in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

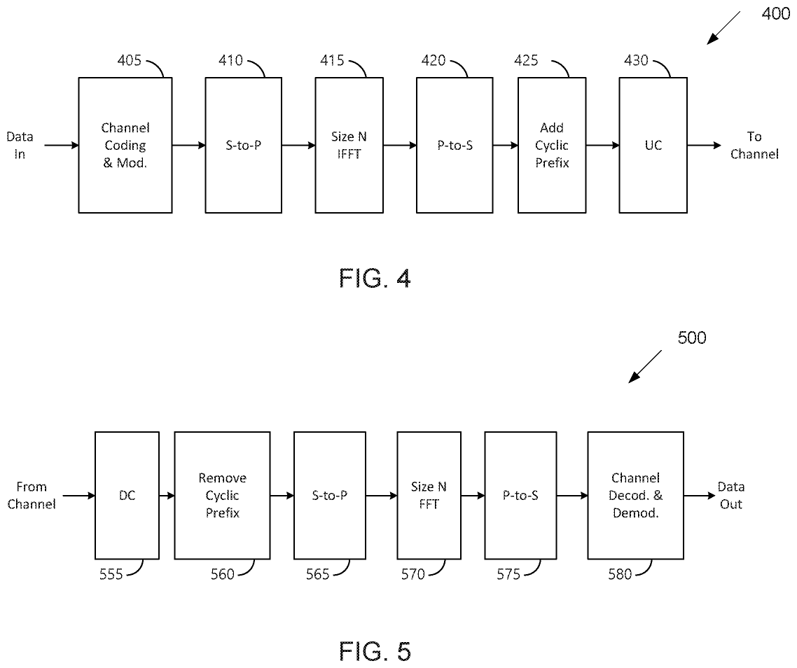

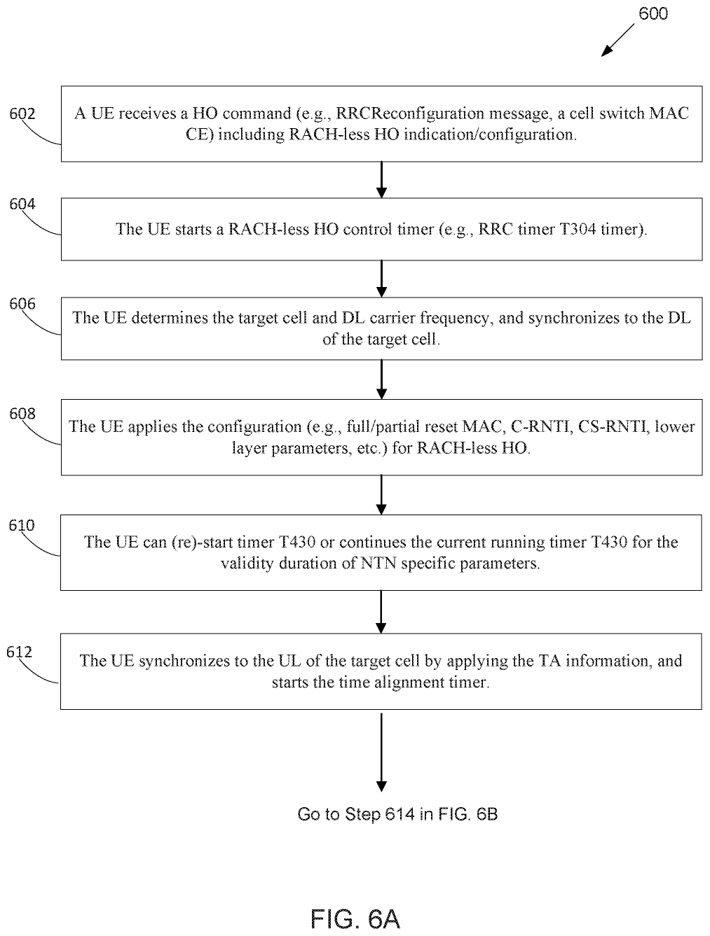

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support a RACH-less handover for a mobility operation in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

3GPP has developed technical specifications and standards to define the new 5G radio-access technology, known as 5G new radio (NR). In Release 17 specification, the non-terrestrial network (NTN) is supported as a vertical functionality by 5G NR. A non-terrestrial network (NTN) providing non-terrestrial NR access to a UE by means of an NTN payload, e.g., a satellite, and an NTN Gateway. The NTN payload transparently forwards the radio protocol received from the UE (via the service link, i.e., wireless link between the NTN payload and the UE) to the NTN Gateway (via the feeder link, i.e., wireless link between the NTN Gateway and the NTN payload) and vice-versa. Considering its capabilities of providing wide coverage and reliable service, NTN is envisioned to ensure service availability and continuity ubiquitously.

For instance, NTN can support communication services in unserved areas that cannot be covered by conventional terrestrial networks, in underserved areas that are experiencing limited communication services, for devices and passengers on board moving platforms, and for future railway/maritime/aeronautical communications. To support NTN in 5G NR, various features need to be introduced or enhanced to accommodate the nature of radio access to NTN that is different to terrestrial networks (TN) such as large cell coverage, long propagation delay, and non-static cell/satellite.

In NTN, the NTN payload can be GSO, i.e., earth-centered orbit at approximately 35786 kilometers above Earth's surface and synchronized with Earth's rotation, or NGSO, i.e., low Earth orbit (LEO) at altitude approximately between 300 km and 1500 km and medium Earth orbit (MEO) at altitude approximately between 7000 km and 25000 km. Depending on different NTN payloads, three types of service links are supported: (1) Earth-fixed: provisioned by beam(s) continuously covering the same geographical areas all the time (e.g., the case of GSO satellites); (2) quasi-Earth-fixed: provisioned by beam(s) covering one geographic area for a limited period and a different geographic area during another period (e.g., the case of NGSO satellites generating steerable beams); and (3) Earth-moving: provisioned by beam(s) whose coverage area slides over the Earth surface (e.g., the case of NGSO satellites generating fixed or non-steerable beams).

With NGSO satellites, a BS can provide either quasi-Earth-fixed cell coverage or Earth-moving cell coverage, while BS operating with GSO satellite can provide Earth fixed cell coverage. Due to different properties of GSO and NGSO, different types of cells can be supported in NTN, which are the earth-fixed cell, the quasi-earth-fixed cell, and the earth-moving cell. For a certain type of NTN payload/cell, specific features or functionalities are desired to be supported by the UE for radio access.

For a UE in a connected state (e.g., RRC_CONNECTED), the NW can provide measurement configuration for a measurement object (e.g., intra-frequency or inter-frequency neighbor cells). Based on the measurement results of a UE, the BS can prepare a handover (HO) from the current serving cell, i.e., source cell, to a target cell and trigger the HO execution by transmitting a HO command in an RRC message (e.g., RRCReconfiguration). The BS can also prepare a conditional HO (CHO) with multiple candidate cells for the UE and transmits CHO configuration in an RRC message (e.g., RRCReconfiguration) to trigger the CHO evaluation.

Due to the large propagation distance between a UE and a gNB in NTN, HO delay and interruption caused by message exchanges between the UE and the gNB can be large. On the other hand, due to the large size of NTN cell, a large number of UEs may need to perform HO almost at the same time for quasi-fixed cell. In order to reduce the HO delay and HO overhead, RACH-less HO, i.e., HO without RACH, is desired.

Similarly, for TN, RACH-less HO can also be applied to reduce the HO delay and HO overhead.

In RACH-less HO, a UE performs DL and UL synchronization autonomously based on configurations in the RACH-less HO command. Then, the UE sends an initial UL transmission to notify its arrival in the target cell and NW confirms UE's arrival by sending a confirmation, in such a way the RACH-less HO is declared to be successfully completed. Thus, UE behavior regarding the initial UL transmission, e.g., UL carrier selection, BWP selection, HARQ procedure, DRX, etc. may be specified.

The present disclosure provides embodiments specifying UE behaviors (e.g., UL carrier selection, BWP selection, HARQ procedure, DRX, etc.) when sending the initial UL transmission in RACH-less HO.

The present disclosure provides solutions on the procedure of RACH-less HO in NTN. In this disclosure, RACH-less HO can refer to a HO procedure without performing Random Access procedure. The procedure can also be applied to mobility in TN.

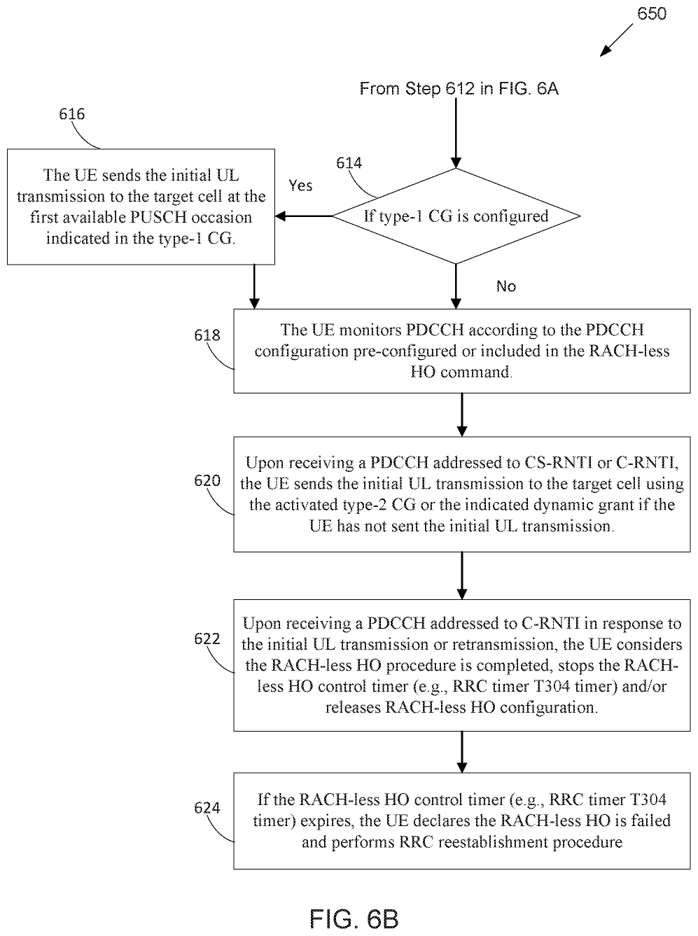

FIGS. 6A and 6B illustrate flowcharts of UE methods 600 and 650 for a RACH-less HO according to embodiments of the present disclosure. The methods 600 and 650 as may be performed by a UE (e.g., 111-116 as illustrated in FIG. 1). An embodiment of the methods 600 and 650 shown in FIGS. 6A and 6B are for illustration only. One or more of the components illustrated in FIGS. 6A and 6B can be implemented in specialized circuitry configured to perform the noted functions or one or more of the components can be implemented by one or more processors executing instructions to perform the noted functions.

As illustrated in FIGS. 6A and 6B, a procedure of RACH-less HO is provided. At operation 602, a UE receives a HO command (e.g., RRCReconfiguration message, a MAC CE). The HO command can be a RRCReconfiguration message including the IE reconfiguration WithSync. The HO command can also be a MAC CE triggering cell switch for L1/L2 triggered mobility. If RACH-less HO configuration or an indication of RACH-less cell switch is included in the HO command, the UE performs RACH-less HO to the target cell indicated in the HO command.

At operation 604, the UE starts a RACH-less HO control timer (e.g., RRC timer T304 timer) to control RACH-less HO operation for the target cell with the timer duration set to the indicated value included in the RACH-less HO command or set to a default value or a pre-configured value.

At operation 606, the UE can determine the DL carrier frequency of the target cell and synchronize to the DL of the target cell. If the frequencyInfoDL is preconfigured or included in the RACH-less HO command, the UE considers the target cell to be one on the SSB frequency indicated by the frequencyInfoDL with a PCI indicated in the RACH-less HO command; otherwise, the UE considers the target cell to be one on the SSB frequency of the source cell with a PCI indicated in the RACH-less HO command. The UE starts synchronising to the DL of the target cell, and/or applies default parameters (e.g., BCCH parameters), and/or acquire MIB of the target cell.

At operation 608, the UE can fully or partially reset the MAC entity of the cell group of PCell according to full or partial reset indication, and/or applies the value of the newUE-Identity as the C-RNTI for this cell group if pre-configured or configured in the RACH-less HO command, and/or applies CS-RNTI if pre-configured or configured in the RACH-less HO command, and/or configures lower layers in accordance with the received parameters (e.g., RACH-less HO configuration) if pre-configured or configured in the RACH-less HO command.

At operation 610, the UE can start or restart RRC timer T430 for the validity duration of NTN specific parameters (e.g., ntn-Config) if NTN specific parameters are included. Alternatively, if an indication of continuing the current running timer T430 is included in the RACH-less HO command, the UE continues the current running timer T430 without (re)-starting the timer. In an example, the UE can determine to (re)-start the timer or to continue the current running timer based on the indication of RACH-less HO type. If intra-satellite intra-BS is indicated, the UE can continue the current running timer T430.

At operation 612, the UE synchronizes to the UL of the target cell by applying the TA information (e.g., N_TA, common TA parameters, NTN ephemeris, etc.) pre-configured or included in the RACH-less HO command. The UE derives the TA value and Doppler frequency offset based on the TA information and NTN specific parameters (e.g., N_TA, common TA parameters, NTN ephemeris, etc.), pre-compensates the TA and Doppler frequency offset for UL transmission.

At operation 612, the UE starts the time alignment timer associated with the TAG configured for the MAC entity of the target cell. The TAG can be indicated in the RACH-less HO command.

At operation 614/616, if type-1 CG is preconfigured or included in the UL grant configuration in the RACH-less HO command, the UE sends the initial UL transmission to the target cell at the first available PUSCH occasion indicated in the type-1 CG. Alternatively, if an UL grant is included in the RACH-less HO command (e.g., cell switch MAC CE), the UE sends the initial UL transmission to the target cell using the indicated UL grant. The initial UL transmission can include a RRCReconfigurationComplete message, and/or C-RNTI MAC CE to confirm the handover. The initial UL transmission can include a TA report MAC CE if ta-Report is configured with value enabled in the RACH-less HO command and/or the UE supports TA reporting and/or the higher layer (e.g., RRC layer) indicates TA report initiation to lower layers (e.g., MAC layer).

The initial UL transmission can include an uplink buffer status report, and/or UL data, whenever possible, to the target cell. As an example, while the RACH-less HO control timer (e.g., RRC timer T304) is running, the UE can retransmit the initial UL transmission (e.g., if retransmission is configured or predefined) using the UL grant configured in type-1 CG. The UE can retransmit periodically according to the configured the type-1 CG while the RACH-less HO control timer (e.g., RRC timer T304) is running. Alternatively, the UE controls the retransmissions by running a retransmission timer. The retransmission timer value can be pre-configured or included in the RACH-less HO command or determined by the UE based on UE-gNB round trip time (RTT). The retransmission timer can be (re)-started upon the end of the first transmission or a retransmission.

At operation 618, if the UE has transmitted initial UL transmission using type-1 CG and/or if type-2 CG is pre-configured or included in the UL grant configuration in the RACH-less HO command and/or if CG is not configured and/or if PDCCH configuration is pre-configured or included in the RACH-less HO command and/or if RACH-less HO command indicates dynamic grant is provided for the initial UL transmission, the UE monitors PDCCH according to the PDCCH configuration pre-configured or included in the RACH-less HO command. In one example, the UE monitors PDCCH that are quasi-co-located with the SSB associated with the UL grant used by the UE for initial UL transmission.

As an example, if the retransmission timer is running, the UE pauses retransmission of the initial UL transmission and/or monitors PDCCH quasi-co-located with the SSB associated with the UL grant used by the UE for the last UL (re)-transmission. If the retransmission timer expires, the UE can retransmit again using the following first available PUSCH occasion configured for the type-1 CG.

At operation 620, if the UE receives a PDCCH addressed to CS-RNTI activating the configured type-2 CG (e.g., with NDI=0) or if the UE receives a PDCCH addressed to C-RNTI or CS-RNTI indicating a dynamic grant (e.g., lower layers (e.g., MAC, PHY) indicates to the higher layer (e.g., RRC) the successful reception of a PDCCH transmission addressed to C-RNTI or CS-RNTI), and if the UE has not sent the initial UL transmission the target cell, the UE sends the initial UL transmission to the target cell using the activated type-2 CG or the indicated dynamic grant. The initial UL transmission can include a configured uplink grant confirmation (e.g., configured grant confirmation MAC CE and/or multiple entry configured grant confirmation MAC CE).

The initial UL transmission can include a RRCReconfigurationComplete message, and/or C-RNTI MAC CE to confirm the handover. The initial UL transmission can include a TA report MAC CE if ta-Report is configured with value enabled in the RACH-less HO command and/or the UE supports TA reporting and/or the higher layer (e.g., RRC layer) indicates TA report initiation to lower layers (e.g., MAC layer). The initial UL transmission can include an uplink Buffer Status Report, and/or UL data, whenever possible, to the target cell.

At operation 620, while the RACH-less HO control timer (e.g., RRC timer T304) is running, the UE can retransmit the initial UL transmission (e.g., if retransmission is configured or predefined) using the activated type-2 CG and/or the indicated dynamic grant. The UE can retransmit periodically according to the activated the type-2 CG while the RACH-less HO control timer (e.g., RRC timer T304) is running.

Alternatively, the UE controls the retransmissions by running a retransmission timer. The retransmission timer value can be pre-configured or included in the RACH-less HO command or determined by the UE based on UE-gNB round trip time (RTT). The retransmission timer can be (re)-started upon the end of the first transmission or a retransmission. As an example, if the retransmission timer is running, the UE pauses retransmission of the initial UL transmission and/or monitors PDCCH quasi-co-located with the SSB associated with the UL grant used by the UE for the last UL (re)-transmission. If the retransmission timer expires, the UE can retransmit again using the following first available PUSCH occasion configured for the type-1 CG.

At operation 622, if the UE receives a PDCCH addressed to C-RNTI with or without DL assignment in response to the initial UL transmission or retransmission (e.g., lower layers (e.g., MAC, PHY) indicates to the higher layer (e.g., RRC) the successful reception of a PDCCH transmission addressed to C-RNTI), the UE considers the RACH-less HO procedure is completed. The UE stops the retransmission timer if running and stops retransmissions of initial UL transmission. The UE stops the RACH-less HO control timer (e.g., RRC timer T304 timer) and/or releases RACH-less HO configuration.

At operation 624, if the RACH-less HO control timer (e.g., RRC timer T304 timer) expires, the UE declares the RACH-less HO is failed and performs RRC reestablishment procedure.

For a RACH-less HO command received at operation 602, in one embodiment, the RACH-less HO configuration can include the TA information. The TA information can include a parameter N_TA, which is to be applied for deriving the timing advance (TA) for the target cell. For example, the TA is derived by T_{TA}=(N_{TA}+N_{TA,offset}+N_{TA,adj}^{common}+N_{TA,adj}^{UE})T_{c}. The value of N_TA can be configured to be 0 or same as the value used for a current serving cell (e.g., PCell, PSCell, SpCell, SCell) or other values based on the BS estimation. If N_TA is not configured, the UE can assume the value is 0 or reuse the same value as for the source cell (e.g., PCell). The value of N_TAoffset is configured or pre-defined in TS 38.133. The value of N_{TA,adj}^{common} and N_{TA,adj}^{UE} are derived by the UE based on common TA parameters, ephemeris and UE location information.

In one embodiment, the RACH-less HO configuration can include the type of NTN RACH-less HO. The type can include intra-satellite intra-BS, inter-satellite, intra-BS, intra-satellite inter-BS, and inter-satellite inter-BS.

In another embodiment, the RACH-less HO configuration can include the UL grant configuration for the UL grant to be applied for the initial UL transmission (e.g., PUSCH). The UL grant can include type-1 configured grant (CG), and/or type-2 CG, and/or dynamic grant (DG). The UL grant configuration can include one or multiple CG configurations (e.g., configuredGrantConfig) to configure type-1 CG and/or type-2 CG. Each CG configuration can indicate a UL grant in terms of time and/or frequency position and indicate the UL grant is type-1 CG or type-2 CG (e.g., type-1 CG is indicated if rrc-ConfiguredUplinkGrant is included in the CG configuration, type-2 CG is indicated if rrc-ConfiguredUplinkGrant is not included in the CG configuration). The UL grant configuration can also include DC configuration.

For a UL grant configured as type-1 CG or type-2 CG or for a UL grant indicated as DG, the corresponding CG configuration or the corresponding DG configuration can include the information of SSB to PUSCH mapping, and/or the information of UL power control and/or power ramping for the initial UL transmission, and/or the information of retransmission of the initial UL transmission (e.g., the timer to control the retransmission).

For example, one or multiple of the following parameters can be included in a CG configuration for type-1 CG and/or type-2 CG and/or included in a DG configuration. For each of the following parameters, a common parameter can be used for type-1 CG and/or type-2 CG and/or DG; alternatively, a type-1 CG specific parameter and/or a type-2 CG specific parameter and/or a DG specific parameter can be defined.

In one example, a parameter (e.g., rachless-DMRS-Ports) to indicate the sets of DMRS ports for SSB to PUSCH mapping is provided as specified in TS 38.213. For example, a bit string of 8 bits can be used to indicate DMRS ports for type-1 DMRS, a bit string of 12 bits can be used to indicate DMRS for type-2 DMRS.

In one example, a parameter (e.g., rachless-NrofDMRS-Sequences) to indicate the number of DMRS sequences for SSB to PUSCH mapping is provide as specified in TS 38.213. As an example, value 1 or 2 can be indicated.

In one example, a parameter (e.g., rachless-SSB-Subset) to indicate SSB subset for SSB to CG PUSCH mapping within one CG configuration is provided. If this parameter is absent, a UE assumes that the SSB set includes all actually transmitted SSBs configured by SIB1. For an example, a bitmap of 4 or 8 or 64 bits can be used to indicate the SSB subset.

In one example, a parameter (e.g., rachless-SSB-PerCG-PUSCH) to indicate the number of SSBs per CG PUSCH is provided. Value one corresponds to 1 SSBs per CG PUSCH, value two corresponds to 2 SSBs per CG PUSCH and so on. As an example, the value of the parameter can be ⅛, ¼, ½, 1, 2, 4, 8, and 16.

In one example, a parameter (e.g., rachless-P0-PUSCH) to indicate P0 value for initial PUSCH for RACH-less HO in steps of 1 dB is provided. As an example, the value can be an integer from −16 to 15.

In one example, a parameter (e.g., rachless-Alpha) to indicate alpha value for initial PUSCH for RACH-less HO is provided. As an example, the value can be 0, 1, 4, 5, 6, 7, 8, and 9.

In one example, a parameter (e.g., rachlessRetransmissionTimer) to indicate the retransmission timer value for the initial UL transmission.

The RACH-less HO configuration can include one or more PDCCH configurations.

The PDCCH configuration can include parameters such as control resource sets (CORESET), search spaces and additional parameters for acquiring the PDCCH for a UE to monitor PDCCH in the indicated control resource sets and/or search spaces. In one example, cell-specific and/or UE-specific PDCCH parameters (e.g., PDCCH-ConfigCommon, PDCCH-Config) can be included. In another example, RACH-less HO specific CORESET and/or search space are configured.

In one example, the information of PDCCH monitoring occasions to SSBs mapping (for example, PDCCH monitoring occasions and related SSB information) can be included, so that a UE can choose to monitor PDCCH monitoring occasion as the BS sweeping all SSBs or based on any detected SSB or based on detected SSB that is above a configured threshold (at operation 618/620/622). The threshold can be included in the PDDCH configuration in the RACH-less HO configuration.

In yet another example, a PDDCH configuration can include beam information (e.g., candidate TCI states, SSB indexes) based on measurement reports sent before the HO, so that a UE can monitor PDCCH using the indicated TCI states and/or SSB indexes (at operation 418/420/422). For instance, the UE can only monitor PDDCH quasi-co-located with the indicated SSB indexes or quasi-co-located with the beams/reference signals indicated by the TCI states.

At operation 614, as an embodiment, if both type-1 CG and type-2 CG are pre-configured or provided in the RACH-less HO command, or if the RACH-less HO command includes an indication that DG may be provided by PDCCH and CG is also pre-configured or provided in the RACH-less HO command, the UE can perform operation 616 and operation 618 simultaneously. If there is any overlap among configured type-1 CG, activated type-2 CG and indicated DG, the UE can follow the legacy rule handling the overlapping CG/DG. Alternatively, the UE can prioritize DG over CG, and/or prioritize type-2 CG over type-1 CG, and/or always prioritize the UL grant earlier in time.

For the initial UL transmission at operation 616 and/or 620, in one embodiment, the configured type-1 CG and/or the activated type-2 CG and/or the indicated DG can be configured/indicated that one or more PUSCH occasions is associated with one or more SSBs. The UE can send initial UL (re)-transmissions at the PUSCH occasions based on the associated SSBs. In one example, a RSRP threshold (e.g., rachless-RSRP-ThresholdSSB) can be configured in the RACH-less HO command commonly for all types of UL grant or specifically for each type of UL grant. The UE can send initial UL (re)-transmissions at the PUSCH occasions based on one of the associated SSBs that is above the RSRP threshold. If none of the SSBs associated with a PUSCH occasion is above the RSRP threshold, the UE can attempt with different PUSCH occasions or the UE can use the SSB with the best RSRP among the associated SSBs while the RACH-less HO control timer (e.g., RRC timer T304) is running.

If none of the SSBs associated with any PUSCH occasion is above the RSRP threshold while the RACH-less HO control timer (e.g., RRC timer T304) is running, in one example, the UE can use the SSB with the best RSRP among the SSBs associated with all PUSCH occasions and performs operation 622; in another example, the UE can initiate random access procedure (e.g., 4-step contention-based RA) using common RA resources pre-configured or configured in RACH-less HO command or provided in the target cell system information and performs operation 622; in yet another example, if there is UL data to transmit the UE can initiate random access procedure (e.g., 4-step contention-based RA) using common RA resources pre-configured or configured in the RACH-less HO command or provided in the target cell system information and performs operation 622; in one more example, the UE can declare the RACH-less HO is failed, and stops the RACH-less HO control timer (e.g., RRC timer T304) and performs RRC reestablishment procedure.

For the initial UL transmission, as an embodiment, the procedure for SSB selection can be as follows. When the UE determines if there is a SSB with SS-RSRP above rachless-RSRP-ThresholdSSB, the UE uses the latest unfiltered L1-RSRP measurement. TABLE 1 shows the initial UL transmission.

TABLE 1
Initial UL transmission

| - | if at least one SSB corresponding to the configured uplink grant with SS-RSRP above | |
|---|---|---|
| | the rachless-RSRP-ThresholdSSB is available: | |
| | - | if this is the initial transmission after receiving the RACH-less HO configuration: |

| | |
|---|---|
| - | select a SSB with SS-RSRP above rachless-RSRP-ThresholdSSB or with the best |
| | SS-RSRP amongst the SSB(s) associated with the configured uplink grant. |

| | |
|---|---|
| - | else if PDCCH addressed to C-RNTI has been received after the initial transmission |
| | after receiving the RACH-less HO configuration: |

| | |
|---|---|
| - | if SS-RSRP of the SSB selected for the previous transmission for RACH-less HO |
| | is above rachless-RSRP-ThresholdSSB or is with the best SS-RSRP and this SSB |
| | is associated with this configured uplink grant: |

| | |
|---|---|
| - | select this SSB. |

| | |
|---|---|
| - | else if SS-RSRP of the SSB selected for the previous transmission for RACH- |
| | less HO is not above rachless-RSRP-ThresholdSSB: |

| | |
|---|---|
| - | select a SSB with SS-RSRP above rachless-RSRP-ThresholdSSB or with the |
| | best SS-RSRP amongst the SSB(s) associated with the configured uplink |
| | grant. |

| | |
|---|---|
| - | if SSB is selected above: |

| | |
|---|---|
| - | indicate the SSB index to the lower layer; |
| - | consider this configured uplink grant as valid. |

In yet another embodiment, while the RACH-less HO control timer (e.g., RRC timer T304) is running, the UE can start an initial UL transmission control timer set to the value configured in the RACH-less HO command upon starting to send initial UL transmission. While the initial UL transmission control timer is running, the UE can use the SSBs above the RSRP threshold or use the SSB with the best RSRP among the SSBs associated with all PUSCH occasions; the UE stops the initial UL transmission control timer upon receiving a PCCH addressed to C-RNTI in response to the initial UL transmission or retransmission, and performs operation 622; upon the initial UL transmission control timer expires, the UE initiates random access procedure (e.g., 4-step contention-based RA) using common RA resources pre-configured or configured in the RACH-less HO command or provided in the target cell system information, and the UE performs operation 622; alternatively upon the initial UL transmission control timer expires, the UE can declare the RACH-less HO is failed, and stops the RACH-less HO control timer (e.g., RRC timer T304) and performs RRC reestablishment procedure.

For the initial UL transmission at operation 616 and/or 620, as an embodiment, if the RACH-less HO command indicates or configures initial UL transmission repetition, the UE can transmit the initial UL transmission with multiple repetitions using the configured type-1 CG and/or the activated type-2 CG and/or the indicated DG. The configuration of initial UL transmission repetition can include repetition resource indications (e.g., in timer and/or frequency and/or spatial, SSB indexes, TCI states), and/or a parameter indicating the repetition number for one transmission, and/or a parameter to indicate the RSRP threshold for UE to choose SSB(s) above the configured threshold for the repetition.

In one embodiment of operation 622, if a UE contention resolution identity MAC CE is received on the PDSCH indicated by the received PDCCH addressed to the C-RNTI, the MAC entity indicates to upper layer (e.g., RRC layer) the successful reception of a PDCCH transmission addressed to the C-RNTI. For the UE contention resolution identity MAC CE in response to the initial UL transmission of RACH-less HO, the UE can ignore the field UE contention resolution identity in the received MAC CE.

For the initial UL transmission, retransmission can be configured in the RACH-less HO command. For example, an explicit indication of retransmission enabled or disabled can be included. In another example, retransmission enabled or disabled can be implicitly indicated by the retransmission timer. If the retransmission timer for the initial UL transmission is configured/present/included in the RACH-less HO command, retransmission is enabled; if the retransmission timer is not configured/present/included in the RACH-less HO command, retransmission is disabled.

If retransmission using the configured grant for initial UL transmission in RACH-less HO is configured/enabled, a UE maintains a timer (e.g., cg-Rachless-RetransmissionTimer), the cg-LTM-RetransmissionTimer controls the duration after a configured grant (re) transmission of a HARQ process of the initial transmission at RACH-less HO (e.g., reconfiguration with sync with rach-less configuration) when the UE may not autonomously initiate a retransmission on the HARQ process. The duration of the timer can be configured by RRC in the RACH-less HO command. Alternatively, the duration of the timer can be determined by the UE with the value equal to the UE-BS round trip time (e.g., UE-gNB RTT).

When the MAC entity has a C-RNTI, temporary C-RNTI, CS-RNTI, G-RNTI or G-CS-RNTI, the MAC entity may for each PDCCH occasion during which the MAC entity monitors PDCCH and for each serving cell: if a downlink assignment for this PDCCH occasion and this serving cell has been received on the PDCCH for the MAC entity's C-RNTI, stop the cg-Rachless-RetransmissionTimer, if it is running, for the corresponding HARQ process for the first PUSCH transmission at LTM cell switch.

If the MAC entity has a C-RNTI, a temporary C-RNTI, or CS-RNTI, the MAC entity may for each PDCCH occasion and for each serving cell belonging to a TAG that has a running timeAlignmentTimer or a running cg-SDT-TimeAlignmentTimer and for each grant received for this PDCCH occasion: if an uplink grant for this serving cell has been received on the PDCCH for the MAC entity's C-RNTI or CS-RNTI, stop the cg-Rachless-RetransmissionTimer for the corresponding HARQ process, if running.

For each serving cell and each configured uplink grant, if configured and activated, the MAC entity may include operation as shown in TABLE 2.

TABLE 2
Operation for MAC entity

| | |
|---|---|
| 1> | if the MAC entity is configured with lch-basedPrioritization, and the PUSCH duration |

of the configured uplink grant does not overlap with the PUSCH duration of an uplink grant
received in a random access response or with the PUSCH duration of an uplink grant addressed
to Temporary C-RNTI or the PUSCH duration of a MSGA payload for this serving cell; or

| | |
|---|---|
| 1> | if the MAC entity is not configured with lch-basedPrioritization, and the PUSCH |

duration of the configured uplink grant does not overlap with the PUSCH duration of an uplink
grant received on the PDCCH or in a random access response or the PUSCH duration of a
MSGA payload for this serving cell:

| 2> | set the HARQ process ID to the HARQ process ID associated with this PUSCH |
|---|---|
| duration; | |
| 2> | if, for the corresponding HARQ process, the configuredGrantTimer is not |

running and cg-RetransmissionTimer is not configured and cg-SDT-
RetransmissionTimer is not configured, and cg-Rachless-Retransmission is not
configured/enabled (i.e., new transmission):

| 3> | if there is an on-going RACH-less HO procedure (e.g., reconfiguration |
|---|---|
| with sync with rach-less configuration) and PDCCH addressed to the MAC | |
| entity's C-RNTI has been received; or | |
| 3> | if there is no RACH-less HO procedure (e.g., reconfiguration with sync |

with rach-less configuration):

| 4> | consider the NDI bit for the corresponding HARQ process to have |
|---|---|
| been toggled; | |
| 4> | deliver the configured uplink grant and the associated HARQ |

information to the HARQ entity.

| | |
|---|---|
| 2> | else if the cg-Rachless-Retransmission is configured/enabled and cg-Rachless- |

RetransmissionTimer is not running for the corresponding HARQ process:

| | |
|---|---|
| 3> | if the configured uplink grant is for the initial transmission at RACH-less |

HO procedure (i.e., initial new transmission for reconfiguration with sync with
rach-less configuration):

| | |
|---|---|
| 4> | consider the NDI bit to have been toggled; |
| 4> | deliver the configured uplink grant and the associated HARQ |

| | information to the HARQ entity. |
|---|---|
| 3> | else if the previous uplink grant delivered to the HARQ entity for the |
| same HARQ process was a configured uplink grant for initial transmission at | |
| RACH-less HO procedure (i.e., initial new transmission for reconfiguration with | |
| sync with rach-less configuration) or for its retransmission; and | |
| 3> | if PDCCH addressed to the MAC entity's C-RNTI has not been received |

on the same HARQ process used for the first PUSCH transmission to the serving
cell (i.e., retransmission for initial transmission):

| | |
|---|---|
| 4> | consider the NDI bit to have not been toggled; |
| 4> | deliver the configured uplink grant and the associated HARQ |

information to the HARQ entity.

For the configured uplink grant for the initial UL transmission for the RACH-less HO procedure (i.e., initial new transmission for reconfiguration with sync with rach-less configuration), the HARQ entity may: identify the HARQ process associated with this grant, and for each identified HARQ process. If a MAC PDU to transmit has been obtained the initial UL transmission, if the uplink grant is not a configured grant configured with autonomousTx, the HARQ entity may deliver the MAC PDU and the configured uplink grant and the HARQ information of the TB to the identified HARQ process, instruct the identified HARQ process to trigger a new transmission, start or restart the configuredGrantTimer, if configured, for the corresponding HARQ process when the transmission is performed if LBT failure indication is not received from lower layers; if the configured uplink grant is for the RACH-less HO procedure (i.e., initial new transmission for reconfiguration with sync with rach-less configuration), start or restart the cg-Rachless-RetransmissionTimer, if cg-Rachless-Retransmission is configured/enabled, for the corresponding HARQ process when the transmission is performed.

Furthermore, for the configured uplink grant for the retransmission of the initial UL transmission for the RACH-less HO procedure (i.e., initial new transmission for reconfiguration with sync with rach-less configuration), the HARQ entity may, deliver the uplink grant and the HARQ information (redundancy version) of the TB to the identified HARQ process, instruct the identified HARQ process to trigger a retransmission, start or restart the cg-Rachless-RetransmissionTimer for the corresponding HARQ process when transmission is performed.

When the cg-Rachless-RetransmissionTimer is started or restarted by a PUSCH transmission, it may be started at the beginning of the first symbol of the PUSCH transmission. If the configuredGrantTimer expires for a HARQ process, the HARQ process may stop the cg-Rachless-RetransmissionTimer, if running.

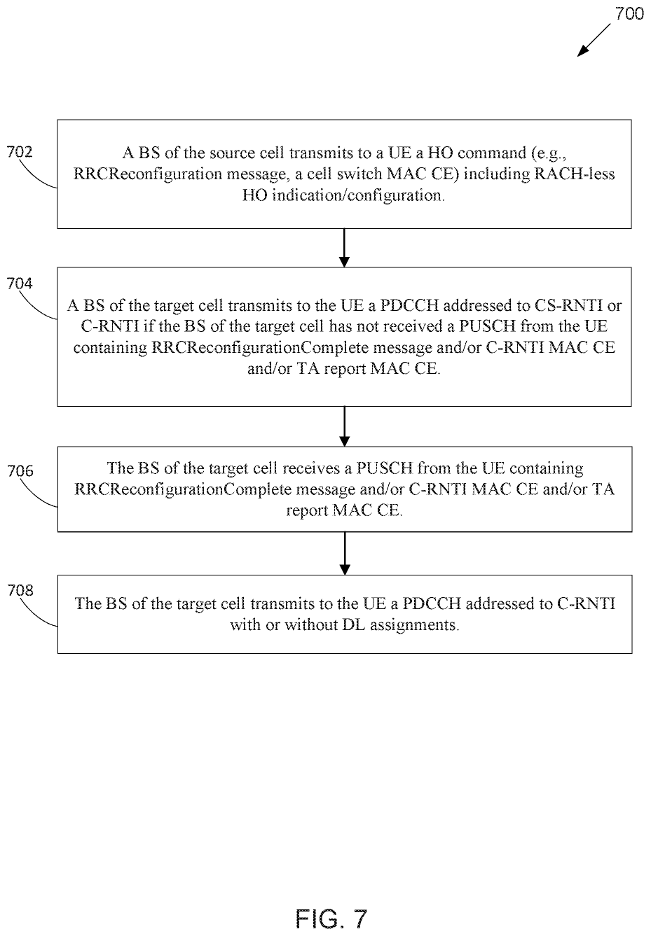

FIG. 7 illustrates a flowchart of BS method 700 for a RACH-less HO according to embodiments of the present disclosure. The method 700 as may be performed by a BS (e.g., 101-103 as illustrated in FIG. 1). An embodiment of the method 700 shown in FIG. 7 is for illustration only. One or more of the components illustrated in FIG. 7 can be implemented in specialized circuitry configured to perform the noted functions or one or more of the components can be implemented by one or more processors executing instructions to perform the noted functions.

As illustrated in FIG. 7, for the network, at operation 702, a BS of the source cell transmits to a UE a HO command (e.g., RRCReconfiguration message, a cell switch MAC CE) including RACH-less HO indication/configuration. At operation 704, a BS of the target cell transmits to the UE a PDCCH addressed to CS-RNTI or C-RNTI if the BS of the target cell has not received a PUSCH from the UE containing RRCReconfigurationComplete message and/or C-RNTI MAC CE and/or TA report MAC CE and/or a configured uplink grant confirmation (e.g., configured grant confirmation MAC CE and/or multiple entry configured grant confirmation MAC CE). At operation 706, the BS of the target cell receives a PUSCH from the UE containing RRCReconfigurationComplete message and/or C-RNTI MAC CE and/or TA report MAC CE and/or a configured uplink grant confirmation (e.g., configured grant confirmation MAC CE and/or multiple entry configured grant confirmation MAC CE), and/or other information. At operation 708, the BS of the target cell transmits to the UE a PDCCH addressed to C-RNTI with or without DL assignments.

As an embodiment, for operation 602/702, the BS can determine the type of HO operation for a UE based on some criteria. The type of HO operation can be L3 (i.e., RRC layer) HO with RACH, L3 RACH-less HO, L1/L2 triggered cell switch with RACH, or L1/L2 triggered cell switch without RACH. As an example, the criteria to determine the type HO operation can be the capability of UE. The BS can determine the type of HO from the UE supported types based on the UE capability indication. As another example, the criteria to determine the type HO operation can be the type of UE. The BS can initiate L3 RACH-less HO for an NTN UE, but not for a TN-only UE.

In one example, the criteria to determine the type HO operation can be the application scenario. A L3 RACH-less HO can be determined when UL synchronization by RACH is not required. A L1/L2 triggered cell switch without RACH can be determined when the cell switch requires low HO latency and UL synchronization is already obtained for the target cell. A L1/L2 triggered cell switch with RACH can be determined when the cell switch requires low HO latency and UL synchronization by RACH is needed. Upon determination of the HO type based on the criteria, the BS sends the corresponding HO command to the UE.

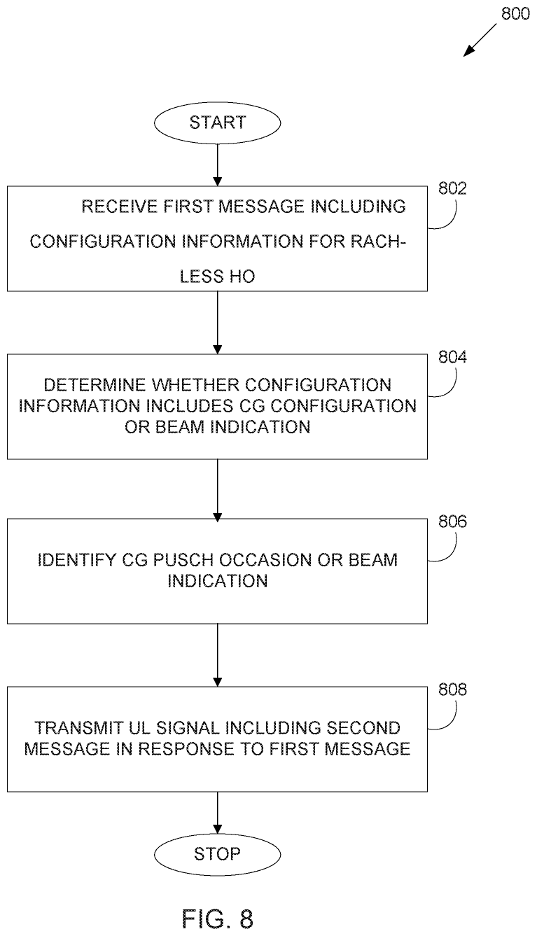

FIG. 8 illustrates a flowchart of a UE method 800 for RACH-less handover for a mobility operation in a wireless communication system. The method 800 as may be performed by a UE (e.g., 111-116 as illustrated in FIG. 1). An embodiment of the method 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

As illustrates in FIG. 8, the method 800 begins at step 802. In step 802, a UE receives a first message including configuration information for performing a RACH-less HO to a target cell, wherein the configuration information includes a CG configuration or a beam indication.

In step 804, the UE determines whether the configuration information includes the CG configuration or the beam indication.

In step 806, the UE identifies a CG PUSCH occasion based on a determination that the configuration information includes the CG configuration or identifies a TCI state ID or a SSB index based on a determination that the configuration information includes the beam indication.

In step 808, the UE transmits, to the target cell, an uplink signal including a second message corresponding to the first message at the identified CG PUSCH occasion when the configuration information includes the CG configuration or transmits, to the target cell, the uplink signal based on an uplink grant received in a PDCCH, the PDCCH being monitored based on the beam indication when the configuration information includes the beam indication.

In one embodiment, the UE applies a value of N_TA to a TAG of the target cell and starts a timer associated with the TAG. In such embodiment, the configuration information further comprises the N_TA setting to zero or the value of N_TA of a serving cell.

In such embodiments, the CG configuration includes at least one of: a RSRP threshold for a SSB selection operation, a mapping between a SSB subset and CG PUSCHs, a number of SSBs per CG PUSCH, a retransmission timer value for a transmission of the UL signal, a number of DMRS sequences for the number of SSBs to the CG PUSCH mapping, and a set of DMRS ports for the number of SSBs to the CG PUSCH mapping, and power control parameters including a value of P0 and an alpha value for the transmission of the UL signal.

In one embodiment, the UE determines at least one SSB in the number of SSBs corresponding to the CG PUSCH with a SS-RSRP beyond the RSRP threshold is available, selects a SSB with an SS-RSRP beyond the RSRP threshold among the number of SSBs corresponding to the CG PUSCH, indicates an index of the selected SSB to a lower layer, and identifies that the CG PUSCH is valid.

In one embodiment, the UE performs a random access procedure for the target cell based on a determination that the at least one SSB in the number of SSBs corresponding to the CG configuration with the S-RSRP beyond the RSRP threshold is unavailable.

In one embodiment, the UE controls a retransmission timer for a time duration after a transmission on the CG PUSCH for a HARQ process of the transmission of the UL signal for the RACH-less HO and prohibits a retransmission of the HARQ process in the time duration. In such embodiment, the first message is a radio resource reconfiguration (RRCReconfiguration) message and the second message is a radio resource reconfiguration complete (RRCReconfigurationComplete) message.

In one embodiment, the UE starts or restarts the retransmission timer for the HARQ process at a beginning instance of a first symbol of the CG PUSCH and stops the retransmission timer for the HARQ process when an uplink grant has been received on the PDCCH addressed to a C-RNTI.

In one embodiment, the UE receives the PDCCH addressed to a C-RNTI with a downlink assignment after the transmission of the UL signal for the RACH-less HO, indicates, to a higher layer, a completion of the RACH-less HO when the RACH-less HO is active and stops a timer (T304).

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive a first message including configuration information for performing a random access channel-less handover (RACH-less HO) to a target cell, wherein the configuration information includes a configured grant (CG) configuration or a beam indication; and
a processor operably coupled with the transceiver, the processor configured to:
determine whether the configuration information includes the CG configuration or the beam indication,
identify a CG physical uplink shared channel (PUSCH) occasion based on a determination that the configuration information includes the CG configuration, or
identify a transmission configuration indication (TCI) state identifier (ID) or a synchronization signal/physical broadcast channel block (SSB) index based on a determination that the configuration information includes the beam indication,
wherein the transceiver is further configured to:
transmit, to the target cell, an uplink signal including a second message in response to the first message at the identified CG PUSCH occasion when the configuration information includes the CG configuration, or
transmit, to the target cell, the uplink signal including a second message in response to the first message based on an uplink grant received in a physical downlink control channel (PDCCH), the PDCCH being monitored based on the beam indication when the configuration information includes the beam indication.

2. The UE of claim 1, wherein:
the configuration information further comprises a timing advance (N_TA) set to zero or a value of N_TA of a serving cell; and
the processor is further configured to:
apply the value of N_TA to a timing advance group (TAG) of the target cell, and
start a timer associated with the TAG.

3. The UE of claim 1, wherein the CG configuration includes at least one of:
a reference signal received power (RSRP) threshold for a SSB selection operation;
a mapping between a SSB subset and CG PUSCHs;
a number of SSBs per CG PUSCH;
a retransmission timer value for a transmission of the uplink signal;
a number of demodulation reference signal (DMRS) sequences for the number of SSBs to the CG PUSCH mapping;
a set of DMRS ports for the number of SSBs to the CG PUSCH mapping; and
power control parameters including a value of P0 and an alpha value for the transmission of the uplink signal.

4. The UE of claim 3, wherein, when performing the transmission of the uplink signal for the RACH-less HO, the processor is further configured to:
determine at least one SSB in the number of SSBs corresponding to the CG PUSCH with a synchronization signal-RSRP (SS-RSRP) beyond the RSRP threshold is available;
select a SSB with the SS-RSRP beyond the RSRP threshold among the number of SSBs corresponding to the CG PUSCH;
indicate an index of the selected SSB to a lower layer; and
identify that the CG PUSCH is valid.

5. The UE of claim 4, wherein, when performing the transmission of the uplink signal for the RACH-less HO, the processor is further configured to perform a random access procedure for the target cell based on a determination that the at least one SSB in the number of SSBs corresponding to the CG configuration with the SS-RSRP beyond the RSRP threshold is unavailable.

6. The UE of claim 1, wherein:
the first message is a radio resource reconfiguration (RRCReconfiguration) message and the second message is a radio resource reconfiguration complete (RRCReconfigurationComplete) message; and
the processor is further configured to:
control a retransmission timer for a time duration after a transmission on the CG PUSCH for a hybrid automatic repeat request (HARQ) process of the transmission of the uplink signal for the RACH-less HO, and
prohibit a retransmission of the HARQ process in the time duration.

7. The UE of claim 6, wherein the processor is further configured to:
start or restart the retransmission timer for the HARQ process at a beginning instance of a first symbol of the CG PUSCH; and
stop the retransmission timer for the HARQ process when an uplink grant has been received on the PDCCH addressed to a cell-radio network temporary identifier (C-RNTI).

8. The UE of claim 1, wherein:
the transceiver is further configured to receive the PDCCH addressed to a cell-radio network temporary identifier (C-RNTI) with a downlink assignment after the transmission of the uplink signal for the RACH-less HO; and
the processor is further configured to:
indicate, to a higher layer, a completion of the RACH-less HO when the RACH-less HO is active, and
stop a timer (T304).

9. A method of user equipment (UE) in a wireless communication system, the method comprising:
receiving a first message including configuration information for performing a random access channel-less handover (RACH-less HO) to a target cell, wherein the configuration information includes a configured grant (CG) configuration or a beam indication;
determining whether the configuration information includes the CG configuration or the beam indication,
identifying:
a CG physical uplink shared channel (PUSCH) occasion based on a determination that the configuration information includes the CG configuration, or
a transmission configuration indication (TCI) state identifier (ID) or a synchronization signal/physical broadcast channel block (SSB) index based on a determination that the configuration information includes the beam indication; and
transmitting, to the target cell:
an uplink signal including a second message in response to the first message at the identified CG PUSCH occasion when the configuration information includes the CG configuration, or
the uplink signal based on an uplink grant received in a physical downlink control channel (PDCCH), the PDCCH being monitored based on the beam indication when the configuration information includes the beam indication.

10. The method of claim 9, further comprising:
applying a value of timing advance (N_TA) to a timing advance group (TAG) of the target cell; and
starting a timer associated with the TAG,
wherein the configuration information further comprises the timing advance (N_TA) setting to zero or the value of N_TA of a serving cell.

11. The method of claim 9, wherein the CG configuration includes at least one of:
a reference signal received power (RSRP) threshold for a SSB selection operation;
a mapping between a SSB subset and CG PUSCHs;
a number of SSBs per CG PUSCH;
a retransmission timer value for a transmission of the uplink signal;
a number of demodulation reference signal (DMRS) sequences for the number of SSBs to the CG PUSCH mapping; and
a set of DMRS ports for the number of SSBs to the CG PUSCH mapping; and
power control parameters including a value of P0 and an alpha value for the transmission of the uplink signal.

12. The method of claim 11, further comprising:
determining at least one SSB in the number of SSBs corresponding to the CG PUSCH with a synchronization signal-RSRP (SS-RSRP) beyond the RSRP threshold is available;
selecting a SSB with the SS-RSRP beyond the RSRP threshold among the number of SSBs corresponding to the CG PUSCH;
indicating an index of the selected SSB to a lower layer; and
identifying that the CG PUSCH is valid.

13. The method of claim 12, further comprising performing a random access procedure for the target cell based on a determination that the at least one SSB in the number of SSBs corresponding to the CG configuration with the S-RSRP beyond the RSRP threshold is unavailable.

14. The method of claim 9, further comprising:
controlling a retransmission timer for a time duration after a transmission on the CG PUSCH for a hybrid automatic repeat request (HARQ) process of the transmission of the uplink signal for the RACH-less HO; and
prohibiting a retransmission of the HARQ process in the time duration,
wherein the first message is a radio resource reconfiguration (RRCReconfiguration) message and the second message is a radio resource reconfiguration complete (RRCReconfigurationComplete) message.

15. The method of claim 14, further comprising:
starting or restart the retransmission timer for the HARQ process at a beginning instance of a first symbol of the CG PUSCH; and
stopping the retransmission timer for the HARQ process when an uplink grant has been received on the PDCCH addressed to a cell-radio network temporary identifier (C-RNTI).

16. The method of claim 9, further comprising:
receive the PDCCH addressed to a cell-radio network temporary identifier (C-RNTI) with a downlink assignment after the transmission of the uplink signal for the RACH-less HO;
indicating, to a higher layer, a completion of the RACH-less HO when the RACH-less HO is active; and
stopping a timer (T304).

17. A base station (BS) in a wireless communication system, the BS comprising:
a processor configured to generate a first message including configuration information for performing a random access channel-less handover (RACH-less HO), wherein the configuration information includes a configured grant (CG) configuration or a beam indication; and
a transceiver operably coupled to the processor, the transceiver configured to transmit the first message that is used for performing a random access channel-less handover (RACH-less HO) to a target cell,
wherein whether the configuration information includes the CG configuration or the beam indication is determined,
wherein a CG physical uplink shared channel (PUSCH) occasion is identified based on a determination that the configuration information includes the CG configuration, or a transmission configuration indication (TCI) state identifier (ID) or a synchronization signal/physical broadcast channel block (SSB) is identified based on a determination that the configuration information includes the beam indication, and
wherein an uplink signal including a second message in response to the first message at the identified CG PUSCH occasion is received for the target cell when the configuration information includes the CG configuration, or the uplink signal based on an uplink grant received in a physical downlink control channel (PDCCH) is received for the target cell, the PDCCH being monitored based on the beam indication when the configuration information includes the beam indication.

18. The BS of claim 17, wherein:
the configuration information further comprises a timing advance (N_TA) set to zero or a value of N_TA of a serving cell; and
the CG configuration includes at least one of:
a reference signal received power (RSRP) threshold for a SSB selection operation,
a mapping between a SSB subset and CG PUSCHs,
a number of SSBs per CG PUSCH,
a retransmission timer value for a transmission of the uplink signal,
a number of demodulation reference signal (DMRS) sequences for the number of SSBs to the CG PUSCH mapping,
a set of DMRS ports for the number of SSBs to the CG PUSCH mapping, and
power control parameters including a value of P0 and an alpha value for the transmission of the uplink signal.

19. The BS of claim 17, wherein the first message is a radio resource reconfiguration (RRCReconfiguration) message and the second message is a radio resource reconfiguration complete (RRCReconfigurationComplete) message.

20. The BS of claim 17, wherein the transceiver is further configured to transmit the PDCCH addressed to a cell-radio network temporary identifier (C-RNTI) with a downlink assignment after the transmission of the uplink signal for the RACH-less HO.
